(19) United States
(12) Patent Application Publication
(10) Pub. No.: US 2004/0251584 A1
(43) Pub. Date: Dec. 16, 2004

(54) Customizing kit for a vehicle air suspension system with an additional air spring volume that can be added

(76) Inventor: Olav Borgmeier, Huckeswagen (DE)

Correspondence Address: Steven L. Oberholtzer, Esq., BRINKS HOFER GILSON & LIONE, P.O. Box 10395, Chicago, IL, 60610, US

(21) Appl. No.: 10/775,414

(22) Filed: Feb. 10, 2004

(30) Foreign Application Priority Data
Feb. 12, 2003 (DE) 203 02 274.2

(51) Int. Cl. F16F 5/00

(52) U.S. Cl. 267/64.11

(57) ABSTRACT

A novel type of customizing kit for a vehicle air suspension system, comprising an additional air spring volume with a connecting line which can be connected to a vehicle main air spring volume, and with a switching device for selective connection or disconnection of the additional air spring volume. The switching device is arranged in the area of the connecting line and is designed such that when it is in an open position, it releases the cross section of the connecting line virtually completely for flow to pass through in both directions and when it is in a closed position, reduces the cross section to a specific residual opening cross section, such that this results in effective closure of the connecting line by use of a Helmholtz effect in a specific region of an excitation frequency of the oscillating air volume.

The present invention relates to a novel type of customizing kit for a vehicle air suspension system, comprising an additional air spring volume with a connecting line which can be connected to a vehicle main air spring volume and with a switching device for selective connection or disconnection of the additional air spring volume.

EP 0 193 851 A2/B1 and the parallel U.S. Pat. No. 4,712,775 disclose a shock absorber or an air suspension leg which has an auxiliary air chamber in addition to a main air chamber. A control valve is also integrated between these two air chambers, which are arranged such that they are integrated in the upper end area of the shock absorber, and this control valve can be operated mechanically by an operating element (actuator) in order to connect the auxiliary air chamber to the main air chamber, or to disconnect the auxiliary air chamber from the main air chamber. An integrated configuration such as this leads to a large physical form, which frequently leads to space problems in modern vehicles. Furthermore, the control valve is complex since it has sealing means and a separate operating element.

U.S. Pat. No. 4,660,810 and GB 2 134 625 also describe a very similar prior art.

DE 100 17 030 A1 describes a specific solenoid valve, in which damping means are provided which act at the limit positions of a magnetic armature and are intended to prevent the armature and the corresponding sealing means from striking hard against one another. The aim of this is to make it possible to disconnect a convenience volume in passenger vehicle air suspension systems very largely without any noise and as a function of the motion dynamics, in order to achieve a harder spring rate. However, this valve is likewise very complicated and its construction involves very considerable effort.

The present invention is based on the object of providing a capability to provide an additional air spring volume for a vehicle air suspension system, which can be connected or disconnected selectively by physically simple and low-cost means, with a further aim being to keep the space requirement in the vehicle small and to allow it to be easily matched to different environmental conditions.

According to the invention, this is achieved by a novel type of customizing kit as claimed in claim 1. Advantageous developments of the invention are contained in the dependent claims.

Thus, according to the invention, the additional air spring volume is physically separate from the shock absorber or suspension leg and its main air spring volume, and can be connected via a connecting line. In consequence, the components of the customizing kit according to the invention can advantageously be positioned in virtually any desired location where sufficient space is available in the vehicle. In this case, furthermore, the particular configuration of the switching device is important to the extent that it is significant to the invention. Thus, in the open position, virtually all of the maximum flow cross section of the connecting line is released for flow to pass through in both directions. In this case, the flow cross section in the open position is chosen to be sufficiently large that a so-called Helmholtz effect is avoided in a frequency range (which can be expected in practice) for a spring excitation frequency. This means that, in the open position, in practice it is impossible for a “dynamic jam” to occur in the connecting line. In contrast to this, the connecting line is deliberately not closed in a completely sealed manner when it is in the closed position, but is closed only as far as a specific residual opening cross section. The invention is therefore based on the discovery that the additional air spring volume is effectively disconnected even at a specific reduced flow cross section, at specific excitation Spectra of the chassis, that is to say in a specific range of the excitation frequency (frequency of the spring movements). This is the result of there being an oscillating air column in the connecting line, with the additional volume being effectively disconnected, despite there being a specific residual opening cross section, due to the inertia of the mass of air above the natural frequency of the oscillating air column. In the specialist world, this is referred to as the Helmholtz effect. The residual opening cross section which remains in the closed position is thus, on the one hand, designed to be sufficiently small that effective closure is achieved by the Helmholtz effect for oscillations that occur in practice; on the other hand, the residual opening cross section is, however, sufficiently large that complete pressure equalization takes place between the main and additional air spring volumes via the switching device when the air suspension is in a steady-state or quasi-steady-state operating condition.

The measures according to the invention advantageously allow the switching device to be designed to be very simple, particularly because no sealing means whatsoever are required for the closed position. Thus, in one preferred embodiment, the switching device is formed by a restrictor valve, which is in the form of a disk, is arranged in the connecting line and is mounted such that it can rotate about a shaft running transversely with respect to the connecting line such that its disk surface is aligned in the longitudinal direction of the connecting line in the open position, and is aligned in the transverse direction in the closed position. In this case, the residual opening cross section in the closed position is formed by a circumferential gap between it and the internal circumference of the connecting line which surrounds the restrictor valve. The restrictor valve can thus advantageously be moved with an extremely small operating force, because it can be mounted with virtually no friction within the connecting line. In a further preferred refinement, it is possible to provide for the restrictor valve to be able to be operated mechanically, without any connection and without any contact, by means of at least one magnetic field from a magnet arrangement which is arranged outside the connecting line. This means that there is also no need for any mechanical operating connections passing through the connecting line, or for associated seals.

The invention will be explained in more detail with reference to the drawings, by way of example, in which:

FIG. 1 shows a highly schematic outline diagram of an air suspension system in order to explain its method of operation,

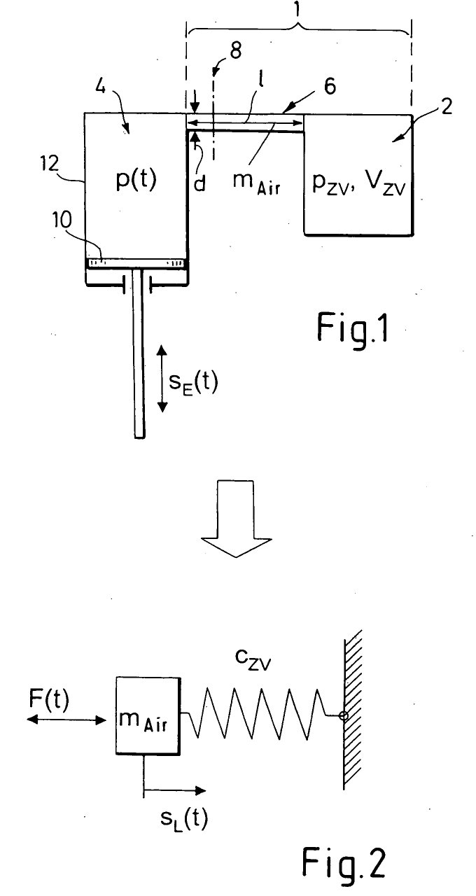

FIG. 2 shows a mechanical equivalent circuit relating to FIG. 1,

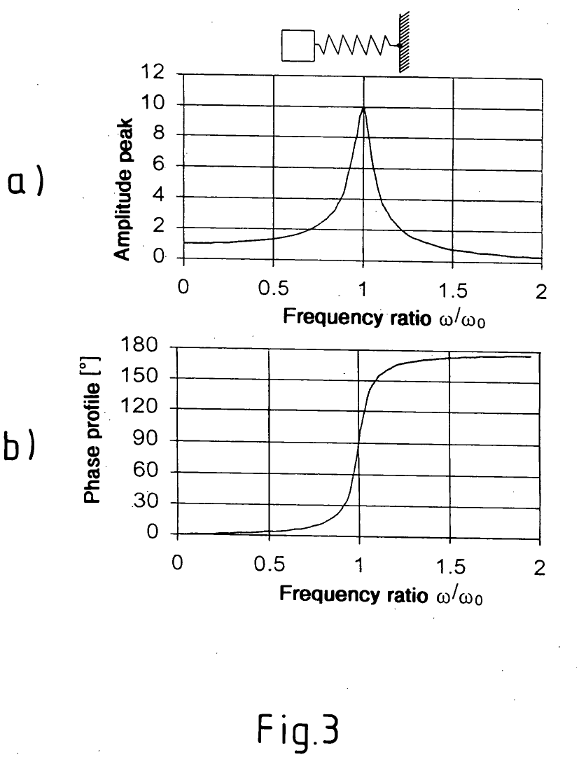

FIG. 3 shows diagrams in order to explain the so-called Helmholtz effect,

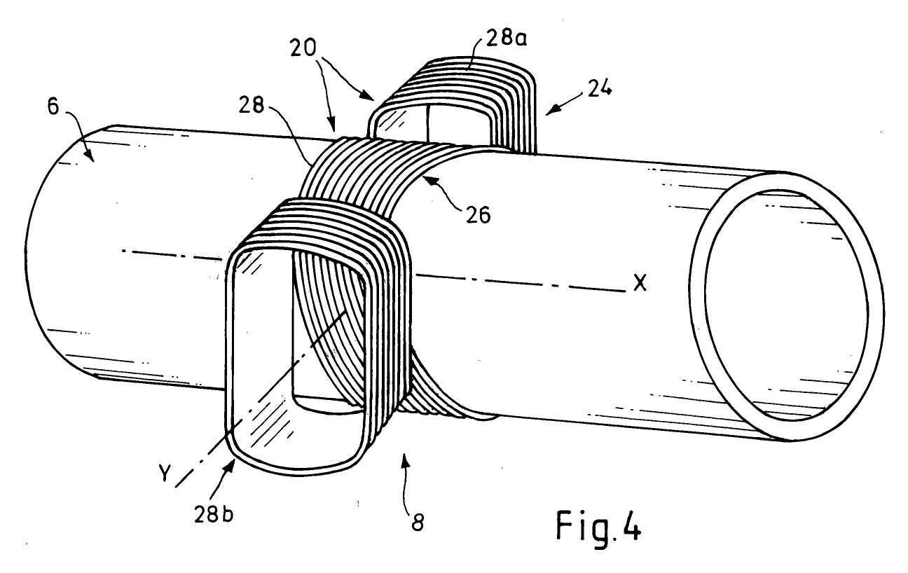

FIG. 4 shows a perspective view of a part of a connecting line as a component of a customizing kit according to the invention, with a first embodiment of a switching device,

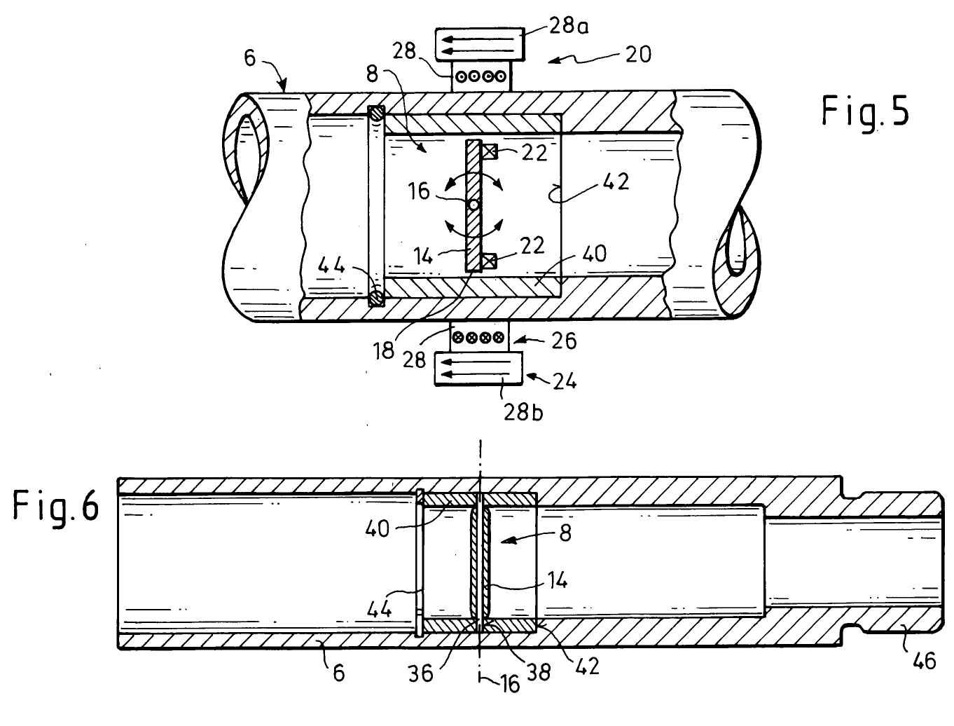

FIG. 5 shows a partial longitudinal section through FIG. 4,

FIG. 6 shows a partial longitudinal section in another section plane, at right angles to the section shown in FIG. 5, and an embodiment variant,

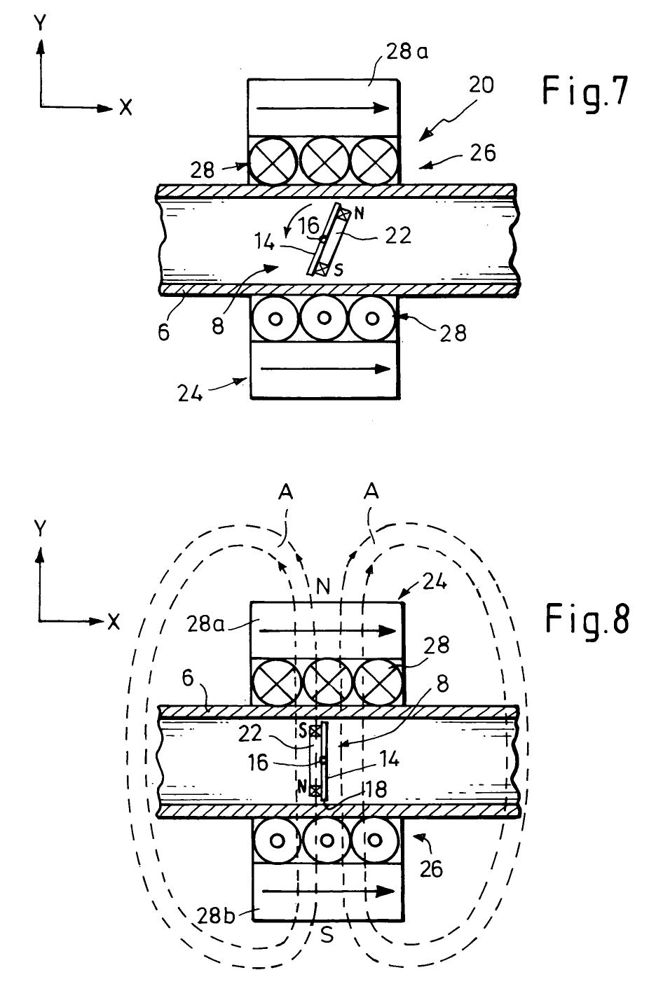

FIGS. 7 to 10 show simplified outline illustrations, analogous to FIG. 5, in order to illustrate various switch positions of the switching device,

FIG. 11 shows a partially sectioned perspective view of one embodiment variant of the switching device,

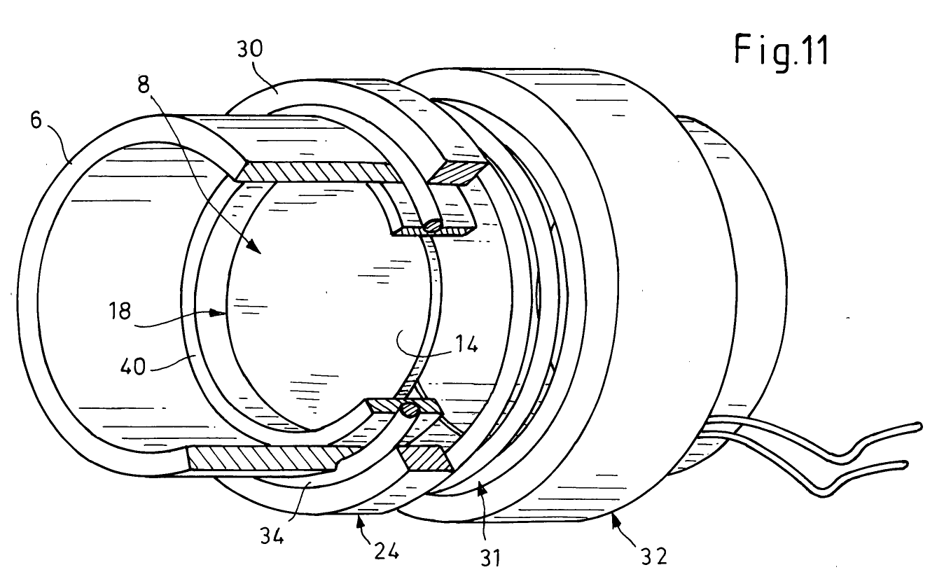

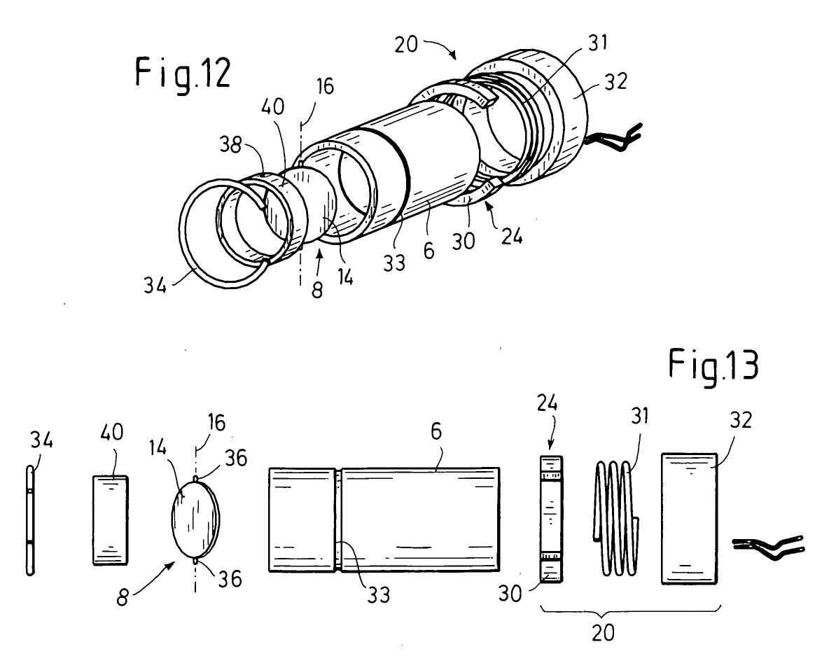

FIG. 12 shows a perspective exploded illustration relating to the embodiment shown in FIG. 11,

FIG. 13 shows an exploded side view of individual parts relating to the embodiment shown in FIGS. 11 and 12,

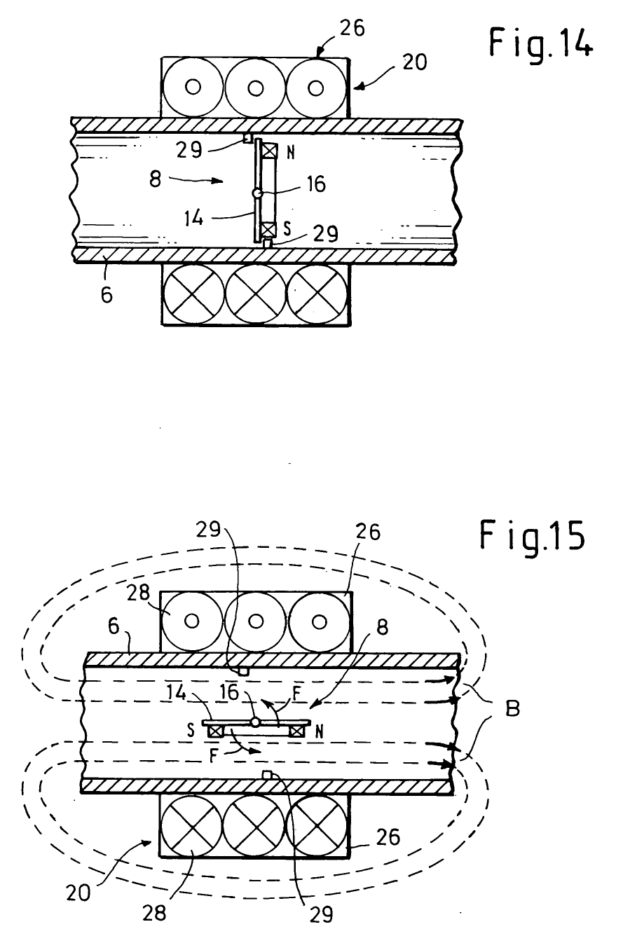

FIGS. 14 and 15 show further outline illustrations, analogous to FIGS. 7 to 10, of a further embodiment variant,

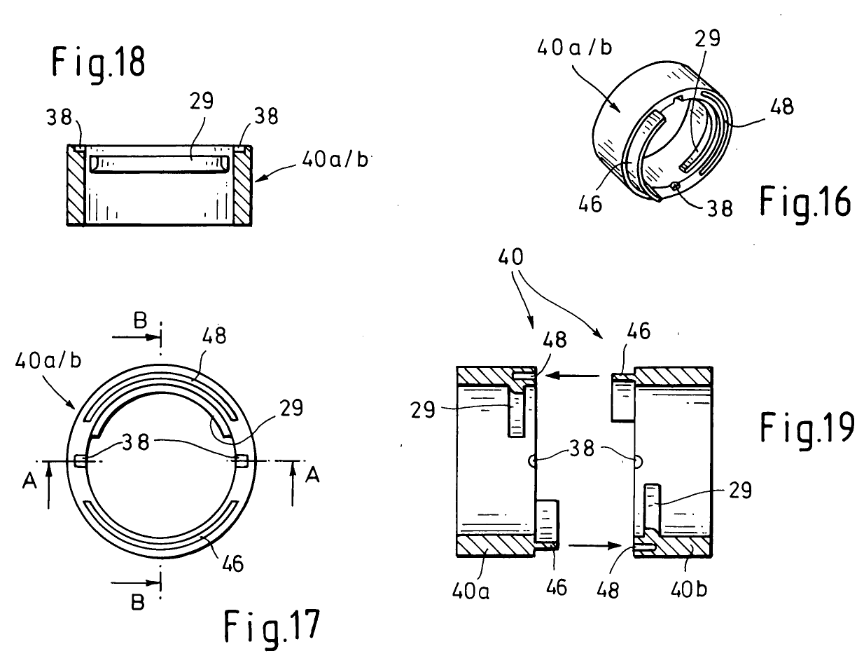

FIG. 16 shows a perspective illustration of one of two bush parts of a retaining bush of the switching device,

FIG. 17 shows an enlarged end view of the bush part shown in FIG. 16,

FIG. 18 shows a diagonal section along the plane A-A as shown in FIG. 17,

FIG. 19 shows a diagonal section along the plane B-B as shown in FIG. 17, additionally illustrating the second bush part in order to explain the installation, and

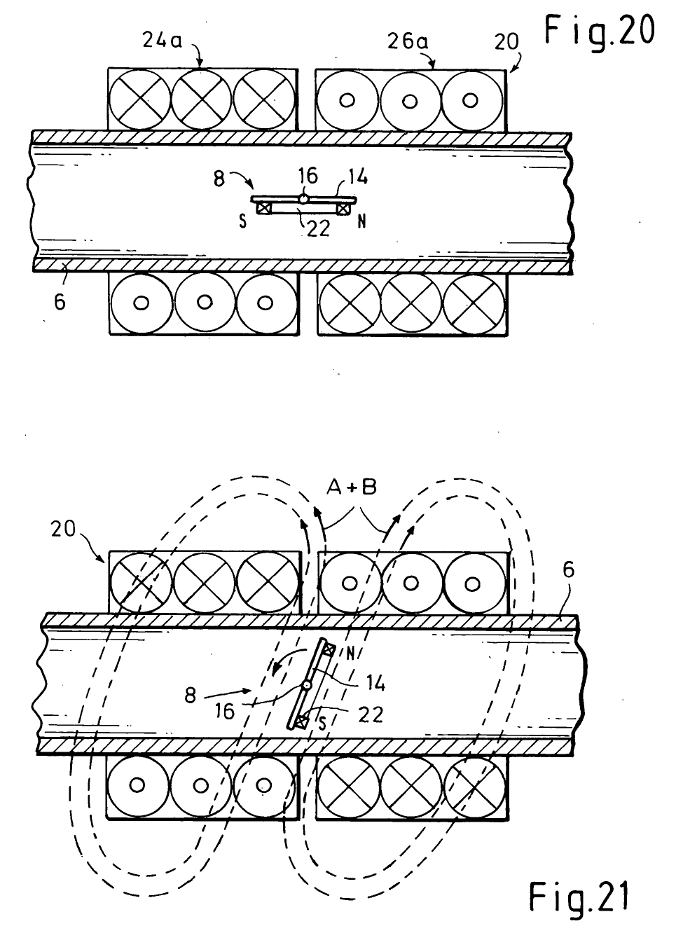

FIGS. 20 to 22 show further embodiment variants in illustrations analogous to FIGS. 7 to 10 and analogous to FIGS. 14 and 15.

As can be seen first of all from FIG. 1, a customizing kit 1 according to the invention comprises an additional air spring volume 2 with a connecting line 6 which can be connected to a main air spring volume 4 and in which a switching device 8 is arranged, which is indicated just by a dash-dotted line in FIG. 1. This switching device 8 can be used to selectively connect the additional volume 2 to the main volume 4 and to disconnect the additional volume 2 from the main volume 4, in order to change the effective spring characteristic as a function of the desired driving characteristics of the vehicle. The connecting line 6 can be connected to the main air spring volume 4 in a manner which can withstand air pressure via a suitable line connector, in particular a plug connection, which is not illustrated separately. This may also apply analogously to the connection of the connecting line 6 to the additional air spring volume 2.

A spring piston 10 acts on the main air volume 4 and is moved in a cylinder 12 corresponding to the spring movements of a wheel. This time-dependent excitation movement is annotated S_{E} (t) in FIG. 1. In consequence, the volume and the pressure p (t) within the main volume 4 vary in a corresponding manner as a function of time.

When the switching device 8 is open, the air volume and the air mass mₐᵢᵣ move within the connecting line 6 corresponding to the input-side excitation frequency with respect to the volume V_{zv} and the pressure p_{zv} of the additional volume 2. Thus, as is shown in FIG. 2, the air mass mₐᵢᵣ acts against the spring constant c_{zv} of the additional volume 4 during the movement s_{L} (t). In other words, the air mass mₐᵢᵣ in the line 6 oscillates on the air spring of the additional volume V_{zv}.

The diameter d as well as the cross section

$${A}_{L} = \frac{{d}^{2} \cdot π}{4}$$

and the length l of the connecting line 6 result in a natural frequency ω₀ (circular frequency) in the connecting line 6, that is to say the so-called Helmholtz natural frequency ω_{eHH} in accordance with the following formula (1):

$${ω}_{0} = {ω}_{eHH} = \sqrt{\frac{{c}_{ZV}}{{m}_{air}}} = d \cdot \sqrt{\frac{n \cdot π \cdot {R}_{air} \cdot T}{4 \cdot {V}_{ZV} \cdot l}}$$

This is subject to the following relationships:

Spring constant of the additional volume (formula (2)):

$${ρ}_{air} \approx \frac{{p}_{zv}}{{R}_{air} \cdot T}$$

Mass of the air in the connecting line 6 (formula (3)):

$${m}_{air} = \frac{{d}^{2} \cdot π}{4} \cdot l \cdot {ρ}_{air}$$

Air density (formula (4)):

$${c}_{zv} = n \cdot {A}_{L}^{2} \cdot \frac{{p}_{zv}}{{V}_{zv}}$$

Rₐᵢᵣ is the gas constant (at approximately 287 J/(kgK)) and T is the temperature in Kelvin. V_{zv} is the size of the additional volume 2. n is the so-called polytropic exponent, normally in the range from 1 to 1.4, which indicates the internal air friction.

The diagrams in FIG. 3 now show the behavior as a function of the ratio of the input-side excitation frequency ω to the natural frequency or Helmholtz frequency ω₀. The following situations may occur:

(a) If the excitation frequency is below the natural frequency, an increase in amplitude leads to additional “pumping out” of the additional air spring volume 2 (phase shift close to 0°). This reduces the effective spring stiffness in the overall system.

(b) Above the natural frequency, the mass oscillates in antiphase (phase shift approximately 180°), which leads to an additional pressure increase in the main spring volume 4, and thus to an increase in the overall spring stiffness.

(c) Well above the natural frequency, the mass virtually no longer oscillates, so that the additional air spring volume 2 is effectively disconnected.

Using these described effects, the invention now provides for the maximum cross section (which is effective when the switching device 8 is in the open position) of the connecting line 6 and its length l to be designed such that the natural frequency is in any case greater, corresponding to the above situation (a), for a range of excitation frequencies which can be expected in practical use, which, from experience in the case of vehicle suspension systems, is 0 to 100 Hz, in particular from 0 to a maximum of 10 to 12 Hz. The following specific embodiment relates to this:

If d=0.01 m=1 cm

V_{zv}=0.0015 m³=1.5 dm³(1.5 l)

L=0.5 m

T=293 K

Rₐᵢᵣ=287 J/(kgK)

n=1.4

this results, according to the above formula (1), in:

$$\begin{matrix}{ω}_{eHH} = 111 \frac{1}{s} \\ {f}_{eHH} = \frac{{ω}_{eHH}}{2 π} = 17.7 Hz\end{matrix}$$

This natural frequency is thus in any case higher than the excitation frequency to be expected.

In contrast to this, when the switching device 8 is in the closed position, the invention deliberately makes use of the described Helmholtz effect in such a way that a remaining residual opening cross section reduces the natural frequency to such an extent that the above situation (c) occurs. However, the residual opening cross section is sufficiently large that complete pressure equalization takes place between the main volume 4 and the additional volume 2 via the switching device 8 when the air suspension system is in a stead-state or quasi-steady-state operating condition, that is to say without oscillations or virtually no oscillation. In practice, the residual opening cross section is, for example, in the region of around 3% of the maximum cross section in the open position.

In one advantageous embodiment, by way of example, a maximum line diameter d of 0 to 200 mm is provided, in particular about 9 to 30 mm. The maximum line cross section A_{L} and the reduced residual cross section can easily be determined on the basis of the conditions described above.

Advantageous exemplary embodiments of the switching device 8 will now be explained with reference to FIGS. 4 to 13.

According to the invention, the switching device 8 is formed by a restrictor valve 14, which is in the form of a disk, is arranged in the connecting line 6 and is mounted such that it can rotate about a shaft 16 running transversely with respect to the connecting line 6 such that its disk surface is aligned on the one hand in the longitudinal direction of the connecting line 6 in the open position, and on the other hand is aligned in the transverse direction in the closed position. The restrictor valve 14 can advantageously rotate with virtually no friction within the connecting line 6, since its external circumferential edge is at a distance from the internal circumference of the connecting line 6 in all positions. Even in the closed position, this therefore results in a residual opening cross section through a circumferential gap 18 which surrounds the restrictor valve 14, as can be seen from the closed position as illustrated in both FIGS. 5 and 8. This circumferential gap 18 and the residual opening cross section which results from it are dimensioned on the basis of the criteria explained above.

Since the bearings for the restrictor valve 14 are the subject of virtually no friction, it is advantageously possible to operate the restrictor valve 14 mechanically, without any connection and without any contact, by means of at least one magnetic field A, B from a magnet arrangement 20 which is arranged outside the connecting line 6. For this purpose, the restrictor valve 14 is magnetized with two or more poles. The magnetization may be axial, radial or in sector form on the surface. Depending on the embodiment, the alignment may be oriented isotropically, anisotropically, or in a polar form. For example, the restrictor valve 14 is magnetized diametrically such that it can be aligned corresponding to the profile (as produced within the connecting line 6) of the magnetic field A/B from the external magnet arrangement 20 (like a compass needle). As is shown in FIGS. 5 and 7 to 10, the restrictor valve 14 may for this purpose have a correspondingly diametrically magnetized magnet element 22, which is mounted on one surface for example, in particular a ring magnet. However, in one preferred refinement, the restrictor valve 14 is itself composed of an appropriately diametrically magnetized material, to be precise in particular of a plastic-bonded permanent magnet (plastic with permanent magnet particles embedded in it). In this context, reference should be made to the variant shown in FIG. 6.

The magnet arrangement 20 which is arranged externally in the area of the connecting line 6 comprises at least one magnet element which is electromagnetically in the form of a solenoid coil which can be controlled electrically and/or can be moved physically, or is in the form of a permanent magnet which can be moved physically. If there are a number of magnet elements, for example two, it is also possible to use any desired combination of a solenoid coil or coils and a permanent magnet or magnets.

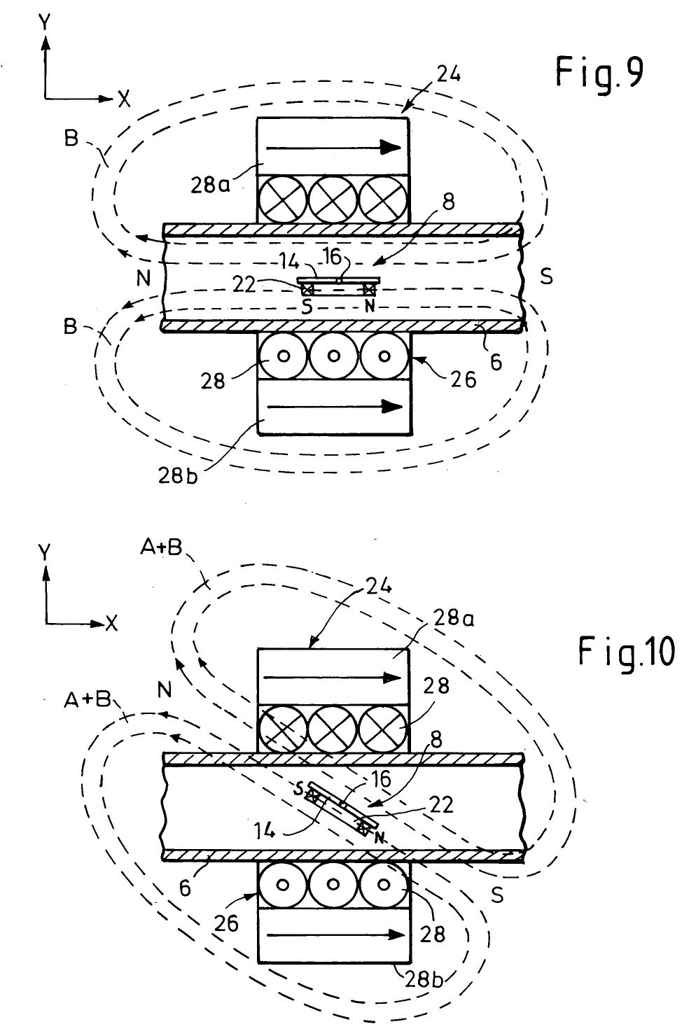

Two magnet elements 24 and 26 are provided in the embodiments illustrated in FIGS. 5 and 7 to 10. In this case, both magnet elements 24 and 26 are formed by solenoid coils 28. In order to produce a first magnetic field A which runs within the connecting line 6 and transversely with respect to it (axis direction Y)—see FIG. 8—the first magnet element 24 comprises two coil elements 28a and 28b, which are arranged on diametrically opposite sides of the connecting line 6, with the coil axis being aligned transversely with respect to the connecting line 6, corresponding to the profile of the magnetic field A. The second magnet element 26 is in the form of a solenoid coil 28 which coaxially surrounds the connecting line 6, so that both the coil axis and the resultant magnetic field B run in the longitudinal direction within the connecting line 6 (axis direction X, see FIG. 9). In this embodiment, the restrictor valve 14 can rotate freely about the shaft 16, in which case it can be aligned in the closed position, as is shown in FIG. 8, by the magnetic field A of the first magnet element 24 (solenoid coils 28a and 28b) and can be aligned in the open position, as is shown in FIG. 9, by the magnetic field B of the other magnet element 26 (solenoid coil 28).

As is shown in FIG. 10, it is also in principle possible to provide for the capability of the restrictor valve 14 to be aligned in any desired intermediate position by superimposition of the magnetic fields A and B of the two magnet elements 24 and 26. For this purpose, the solenoid coils 28 and 28a, b are supplied with appropriate voltages via control means. In this case, care must be taken to ensure that the magnetic fields A, B are strong enough that the position of the restrictor valve remains largely constant even when flow is passing through it. In this embodiment, the restrictor valve 14 does not just act as a switching device, but also as a controllable restriction.

In one embodiment variant, which is illustrated in FIGS. 14 and 15, the restrictor valve 14 has a rest position which is governed by a spring force F and has a mechanical end stop, from which it can be moved to an operating position by means of only one magnetic field B, from a magnet element 25 in the external magnet arrangement 20. In this case, the rest position is in particular the closed position (FIG. 14) and the operating position is the open position (FIG. 15). However, the situation can also be reversed without any problems. A torsion spring (torsion rod spring) can advantageously be provided to produce a spring force such as this, and then at the same time forms a bearing shaft for the rotating bearing for the restrictor valve 14. In this case, on the one hand, the restrictor valve 14 is connected to the torsion spring, which acts as a diametrical bearing shaft (shaft 16), such that they rotate together (such that their torques are locked), and, on the other hand, the torsion spring is held at the end in the connecting line 6 such that it cannot rotate. Stop elements 29 which project radially inwards are arranged on the internal circumference within the connecting line 6, for example, as an end stop.

In addition, only one magnet element 24 is provided in the embodiment shown in FIGS. 11 to 13, with the restrictor valve 14 having a closed position which is produced by a spring. The magnet element 24 is formed by a permanent magnet 30 which coaxially surrounds the connecting line 6 as an anisotropic ring magnet, but in this case can move axially (in the X axis direction).

This movement is produced by an actuator coil 32 against the force of a restoring spring 31.

As is shown in FIG. 11, the axial movement of the permanent magnet 30 is limited between the actuator coil 32 and a locking ring 34 which is seated in an annular groove 33 (see FIGS. 12 and 13) on the outside on the connecting line 6.

In order to provide the restrictor valve 14 with a rotating bearing which is simple, has low friction and can be assembled easily, it is possible to provide for the restrictor valve 14 to be mounted such that it can rotate freely via diametrical shaft ends 36 within the connecting line 6, to be precise in particular in bearing openings 38 in a retaining bush 40 which is inserted into the connecting line 6, or to be held in a rotationally fixed manner in the case of the torsion/torsion rod spring mentioned above. For assembly, the restrictor valve 14 is first of all inserted into the retaining bush 40. A shaft, which is formed by a metal pin for example, is then pushed from the outside through the bearing openings 38 in the retaining bush 40 and through an aligned bearing opening, which runs diametrically, in the restrictor valve 14. Finally, the retaining bush 40 is inserted axially, together with the restrictor valve 14, into the connecting line 6 and is fixed, for example, between an inner contact step 42 and a locking ring 44 (in this context, see FIGS. 5 and 6). In this embodiment, the described circumferential gap 18 is formed between the external circumference of the restrictor valve 14 and the internal circumference of the retaining bush 40.

In a further embodiment, which is illustrated in FIGS. 16 to 19, the retaining bush 40 is subdivided in order to simplify assembly into two bush parts 40a and 40b, which are in this case each annular, in a division plane which in this case runs, for example, radially, that is to say transversely with respect to the connecting line 6 through the bearing openings 38, such that the two parts 40a, b can be joined together holding the shaft ends 36 of the restrictor valve 14 (in this context, see in particular FIG. 19). In this case, a force-fitting and/or interlocking plug connection with axial plug attachments 46 and corresponding plug openings 48 is preferably provided, which plug attachments 46 and corresponding plug openings 48 can be inserted axially one inside the other (FIG. 19). It is also advantageous for the two parts 40a and 40b to be identical and to have the capability to be plugged together after a specific relative rotation through 180°. In this case, furthermore, the stop elements 29 of the restrictor valve 14 may, for example, be arranged in the form of radial annular web sections within the retaining bush 40 or the bush parts 40.

In contrast to the embodiment illustrated in FIGS. 16 to 19, the retaining bush 40 may also be split into two bush half-shells in a plane running axially. In this case, the division plane need not necessarily pass through the bearing openings 38.

This advantageous embodiment of the split retaining bush 40 allows the restrictor valve 14 to be connected in a fixed (non-detachable) manner to its shaft or its shaft ends 36. For example, a shaft pin (which is not illustrated) may have a plastic-bonded magnet which forms the restrictor valve 14, extrusion-coated directly on it. In order to achieve a good union in this case, the shaft pin may have a roughened, in particular knurled, surface in its area to be extrusion-coated.

In a further advantageous refinement, although this is not illustrated in detail, the restrictor valve 14 may be asymmetrically subdivided into a flap section which has a relatively large area and a flap section which has a relatively small area by the transversely running shaft 16, such that, when it is in the open position, any fluttering movements caused by the flow are counteracted by the larger flap section being aligned in a stable manner in the flow direction by the flow—like a “flag in the wind”.

As is also evident from FIG. 6, the connecting line 6 may advantageously be in the form of a rigid, dimensionally stable pipeline composed of a non-magnetic material, which may be equipped at least at one end with a threaded connection 46 (for example an externally threaded connecting stub).

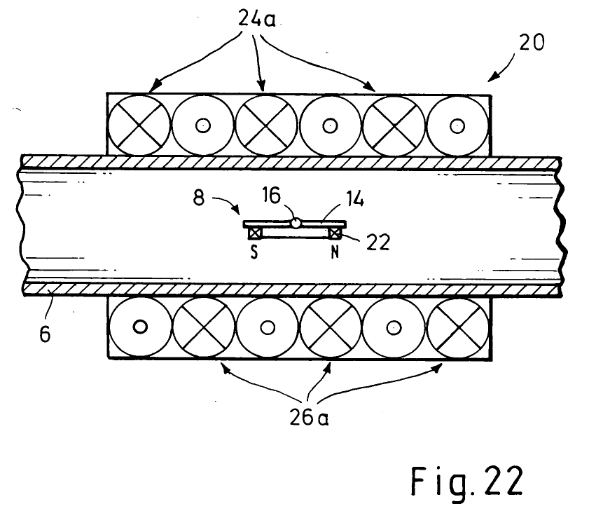

Finally, as can also be seen from the embodiment shown in FIGS. 20 and 21 as well as FIG. 22, the magnet arrangement 20 in this case once again comprises two magnet elements 24a and 26a, although these produce two magnetic fields A, B which run parallel to one another but with opposite polarities. In the illustrated examples, the two fields A and B run along the axis of the connecting line 6, although they could also both run transversely with respect to it. The opposite polarization allows the resultant magnetic fields A+B to be produced whose profiles differ because the magnet elements 24a, 26a are driven differently, in order to align the restrictor valve 14 appropriately in order to set different positions. As is shown in FIGS. 20 and 21, the magnet elements 24a, 26a may be arranged axially alongside one another or, as is shown in FIG. 22, they may be in the form of a unit, for example, as a coil which is duplicated but through which current flows in opposite directions.

Furthermore, it is also possible to combine fields which are aligned longitudinally and are parallel but in opposite directions with fields which are aligned transversely and are parallel but in opposite directions, in the sense of the embodiment shown in FIGS. 4 to 10.

The invention is not restricted to the illustrated and described exemplary embodiments, but also covers all embodiments with the same effect for the purposes of the invention. Furthermore, so far, the invention has also not yet been restricted to the feature combination as defined in claim 1, but may also be defined by any other desired combination of specific features of all of the individual features disclosed overall. This means that, in principle, virtually any individual feature of claim 1 may be omitted or may be replaced by at least one individual feature which is disclosed at some other point in the application. To this extent, claim 1 should be regarded only as a first formulation attempt for an invention. A corresponding situation also applies to the independent claim 14.

1. A customizing kit for a vehicle air suspension system, comprising an additional air spring volume with a connecting line which can be connected to a vehicle main air spring volume and with a switching device for selective connection or disconnection of the additional air spring volume, with the switching device being arranged in an area of the connecting line and being designed such that, when the switching device is in an open position, the switching device releases the cross section of the connecting line virtually completely for flow to pass through in both directions and when the switching device is in a closed position, reduces the cross section to a specific residual opening cross section, such that an effective closure of the connecting line results by use of the so-called Helmholtz effect in a specific region of an excitation frequency of the oscillating air volume.

2. The customizing kit as claimed in claim 1, wherein the switching device is formed by a restrictor valve, which is in the form of a disk, is arranged in the connecting line and is mounted such that restrictor valve can rotate about a shaft running transversely with respect to the connecting line such that a disk surface of the restrictor valve is aligned in the longitudinal direction of the connecting line in the open position, and is aligned in the transverse direction in the closed position, with the residual opening cross section in the closed position being formed by a circumferential gap which surrounds the restrictor valve.

3. The customizing kit as claimed in claim 2, wherein the restrictor valve can be operated mechanically, without any connection and without any contact, by means of at least one magnetic field from a magnet arrangement which is arranged outside the connecting line.

4. The customizing kit as claimed in claim 3, wherein the restrictor valve is mounted via opposite shaft ends within the connecting line, in particular in bearing openings in a retaining bush which is inserted into the connecting line.

5. The customizing kit as claimed in claim 4, wherein the retaining bush is subdivided into two parts in a radial or axial plane which preferably runs through the bearing openings, such that the two parts can be joined together, holding the shaft ends of the restrictor valve.

6. The customizing kit as claimed in claim 3, wherein the restrictor valve is magnetized such that it can be aligned in a corresponding manner to the magnetic field from the external magnet arrangement.

7. The customizing kit as claimed in claim 6, wherein the restrictor valve has a correspondingly magnetized magnet element, in particular a ring magnet.

8. The customizing kit as claimed in claim 6, wherein the restrictor valve is composed of a plastic-bonded permanent magnet.

9. The customizing kit as claimed in claim 3, wherein the external magnet arrangement has at least one magnet element which is electromagnetically in the form of a solenoid coil which can be controlled electrically or can be moved physically, or is in the form of a permanent magnet which can be moved physically.

10. The customizing kit as claimed in claim 3, wherein the restrictor valve has a rest position which is governed by spring force and has a mechanical end stop, from which it can be moved to an operating position by means of the magnetic field from the external magnet arrangement.

11. The customizing kit as claimed in claim 3, wherein the restrictor valve can rotate freely about the shaft, with the magnet arrangement having a first and second magnet element such that the restrictor valve can be aligned in the closed position by the magnetic field of the first magnet element and can be aligned in the open position by the magnetic field of the second magnet element.

12. The customizing kit as claimed in claim 11, wherein the restrictor valve can be aligned in any desired intermediate position by superimposition of the magnetic fields of the first and second magnet elements.

13. The customizing kit as claimed in claim 2, wherein the restrictor valve is asymmetrically subdivided into two valve sections by the shaft, such that, when restrictor valve is in the open position, fluttering movements caused by the flow are avoided.

14. A switching device for a customizing kit, having a restrictor valve which can be arranged in a connecting line and can rotate between an open position and a closed position, with a specific residual opening cross section remaining in the closed position.

15. The switching device as claimed in claim 14, wherein a magnet arrangement, which can be arranged outside the connecting line in the vicinity of the restrictor valve, in order to mechanically operate the restrictor valve without any connection and without any contact, with the restrictor valve being magnetized with two or more poles.

16. The switching device as claimed in claim 15, wherein the magnet arrangement has at least two magnet elements for producing superimposed magnetic fields for the purpose of alignment of the restrictor valve on the basis of an overall magnetic field which results from the superimposed magnetic fields.

17. The switching device as claimed in claim 16, wherein a first magnet element produces a magnetic field which runs transversely within the connecting line and a second magnet element produces a magnetic field which runs longitudinally within the connecting line.

18. The switching device as claimed in claim 16, wherein at least two magnet elements are provided in order to produce magnetic fields which run parallel but have opposite polarity.

19. The switching device as claimed in claim 15, wherein the magnet arrangement has at least one solenoid coil which can be driven electrically or can be moved mechanically, or has at least one permanent magnet which can be moved mechanically.
